(19) United States
(12) Patent Application Publication
(10) Pub. No.: US 2023/0114382 A1
(43) Pub. Date: Apr. 13, 2023

(54) MEMBER FOR OPTICAL GLASS PRODUCTION APPARATUS

(71) Applicant: KYOCERA Corporation, Kyoto-shi, Kyoto (JP)

(72) Inventors: Takahiro YONEDA, Muko-shi, Kyoto, Japan (JP); Masato HASHIMOTO, Kirishima-shi, Kagoshima, Japan (JP)

(21) Appl. No.: 17/802,931

(22) PCT Filed: Feb. 26, 2021
(86) PCT No.: PCT/JP2021/007583

§ 371 Date: Aug. 26, 2022

(30) Foreign Application Priority Data
Feb. 28, 2020 (JP) 2020-033400
Mar. 26, 2020 (JP) 2020-056892

(51) Int. Cl. C04B 35/584

(52) U.S. Cl. CPC C04B 35/584; C04B 2235/3873; C04B 2235/945; C04B 2235/9692

(57) ABSTRACT

A member for optical glass production apparatus is a member exposed to a gas containing a halogen element in a high temperature environment; the member includes a first member (4) directly or indirectly supporting an optical glass (10) and a second member (5) supporting the first member (4).

### TECHNICAL FIELD

The disclosed embodiments relate to a member for optical glass production apparatus.

### BACKGROUND OF INVENTION

A member used for an optical glass production apparatus that manufactures optical glass (hereinafter, also referred to as a member for optical glass production apparatus) may be exposed to a corrosive gas in a high temperature environment in the process of producing such optical glass (see, for example, Patent Document 1).

### CITATION LIST

### Patent Literature

Patent Document 1: JP 07-29807 B

### SUMMARY

### Problem to be Solved

However, in the known art, when a support member supporting an optical glass is corroded, the entire support member needs to be replaced, causing a rise in the production cost of optical glass.

An aspect of an embodiment, made in view of the above, provides a member for optical glass production apparatus that can decrease the production cost of optical glass.

### Solution to Problem

In an aspect of an embodiment, a member for optical glass production apparatus is a member exposed to a gas containing a halogen element in a high temperature environment, the member including a first member directly or indirectly supporting an optical glass and a second member supporting the first member.

### BRIEF DESCRIPTION OF THE DRAWINGS

FIG. 1 is a diagram for describing a configuration of an optical glass production apparatus according to a first embodiment.

FIG. 2 is a diagram for describing a configuration of an optical glass production apparatus according to the first embodiment.

FIG. 3 is a diagram for describing a configuration of a first member according to the first embodiment.

FIG. 4 is a diagram for describing a configuration of a second member according to the first embodiment.

FIG. 5 is a diagram for describing a support method by which the second member supports the first member in the first embodiment.

FIG. 6 is a diagram for describing a support structure by which the second member supports the first member in the first embodiment.

FIG. 7 is a diagram for describing a configuration of a first member according to Variation 1 of the first embodiment.

FIG. 8 is a diagram for describing a configuration of a second member according to Variation 1 of the first embodiment.

FIG. 9 is a diagram for describing a support method by which the second member supports the first member in Variation 1 of the first embodiment.

FIG. 10 is a diagram for describing a support structure by which the second member supports the first member in Variation 1 of the first embodiment.

FIG. 11 is a diagram for describing a configuration of a first member according to Variation 2 of the first embodiment.

FIG. 12 is a diagram for describing a configuration of an optical glass production apparatus according to a second embodiment.

FIG. 13 is a diagram for describing a configuration of an optical glass production apparatus according to the second embodiment.

FIG. 14 is a diagram for describing a configuration of a first member according to the second embodiment.

FIG. 15 is a diagram for describing a configuration of a second member according to the second embodiment.

FIG. 16 is a diagram for describing an installation method by which a cover member is installed on the second member according to the second embodiment.

FIG. 17 is a diagram for describing a support method by which the second member according to the second embodiment supports the first member.

FIG. 18 is a diagram for describing a structure of a support member according to the second embodiment.

FIG. 19 is a diagram for describing a configuration of a first member according to Variation 1 of the second embodiment.

FIG. 20 is a diagram for describing a configuration of a second member according to Variation 1 of the second embodiment.

FIG. 21 is a diagram for describing a support method by which the second member supports the first member in Variation 1 of the second embodiment.

FIG. 22 is a diagram for describing a structure of a support member according to Variation 1 of the second embodiment.

FIG. 23 is a diagram for describing a configuration of a first member according to Variation 2 of the second embodiment.

FIG. 24 is a diagram for describing a configuration of a second member according to Variation 2 of the second embodiment.

FIG. 25 is a diagram for describing a support method by which the second member supports the first member in Variation 2 of the second embodiment.

FIG. 26 is a diagram for describing a structure of a support member according to Variation 2 of the second embodiment.

FIG. 27 is a diagram for describing a labyrinth structure inside the support member according to Variation 2 of the second embodiment.

FIG. 28 is a diagram for describing a configuration of a first member according to Variation 3 of the second embodiment.

FIG. 29 is a diagram for describing an installation method by which a cover member is installed on a second member according to Variation 3 of the second embodiment.

FIG. 30 is a diagram for describing a structure of a support member according to Variation 3 of the second embodiment.

FIG. 31 is a diagram for describing a support method by which a second member supports a first member in Variation 4 of the second embodiment.

FIG. 32 is a diagram for describing a support method by which a second member supports a first member in Variation 5 of the second embodiment.

FIG. 33 is a diagram illustrating an SEM observed photograph of a polished surface on an outer peripheral side of a support member.

FIG. 34 is a diagram illustrating an SEM observed photograph of a polished surface at a center portion of a support member.

FIG. 35 is a diagram illustrating an SEM observed photograph of a polished surface on an inner peripheral side of a support member.

FIG. 36 is a diagram illustrating an SEM observed photograph of a fracture surface on an outer peripheral side of a support member.

FIG. 37 is a diagram illustrating an SEM observed photograph of a fracture surface at a center portion of a support member.

FIG. 38 is a diagram illustrating an SEM observed photograph of a fracture surface on an inner peripheral side of a support member.

### DESCRIPTION OF EMBODIMENTS

Hereinafter, embodiments of a member for an optical glass production apparatus disclosed in the present application will be described with reference to the accompanying drawings. Note that the present invention is not limited to the embodiments that will be described below.

### First Embodiment

A member used in an optical glass production apparatus that manufactures optical glass (hereinafter, also referred to as a member for an optical glass production apparatus) may be exposed to a corrosive gas in a high temperature environment in the process of producing such optical glass.

For example, in the process of producing optical glass, the above-described member may be exposed to a gas containing a halogen element [e.g., F (fluorine), Cl (chlorine), and Br (bromine)] in a high temperature environment of 1100° C. or higher.

Since corrosion reaction by a corrosive gas is promoted in such a harsh environment, a support member supporting the optical glass may be corroded. In the known art, the support member as a whole needs to be replaced when corroded. Such replacement causes an increase in the expenses, which in turn leads to a rise in the production cost of optical glass.

As such, a technique to overcome the aforementioned problem and reduce the production cost of optical glass awaits realization.

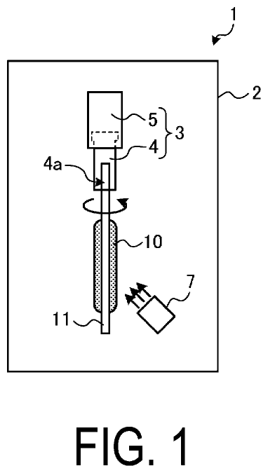

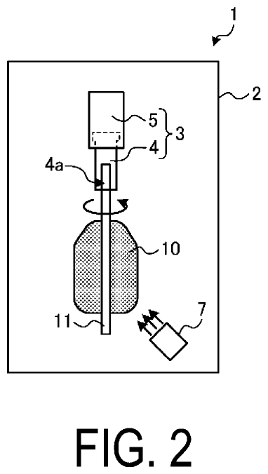

First, a configuration of an optical glass production apparatus 1 according to a first embodiment will be described with reference to FIGS. 1 and 2. FIGS. 1 and 2 are diagrams for describing a configuration of an optical glass production apparatus 1 according to the first embodiment.

FIG. 1 illustrates an initial stage in the production process of optical glass 10, and FIG. 2 illustrates a later stage in the production process of optical glass 10.

As illustrated in FIG. 1, the optical glass production apparatus 1 according to the first embodiment includes a high temperature furnace 2, a support member 3, and a raw material supplier 7. The support member 3 and the raw material supplier 7 are provided inside the high temperature furnace 2. The support member 3 is an example of a member for optical glass production apparatus.

The high temperature furnace 2 can form a high temperature environment (e.g., the temperature is from 1100° C. to 1600° C.) inside, which is required in a production process of the optical glass 10.

The support member 3 includes a first member 4 and a second member 5. The support member 3 supports a glass rod 11, which is a starting material for the optical glass 10. In the first member 4, an insertion portion 4a through which the glass rod 11 can be inserted is formed, for example. The first member 4 supports the glass rod 11 in a manner that the glass rod 11 is hanging by the insertion portion 4a.

That is, in the first embodiment, the first member 4 indirectly supports the optical glass 10 that is being processed. Note that the support method by which the first member 4 supports the glass rod 11 is not limited to the above-described technique. In the first embodiment, the first member 4 may directly support the optical glass 10 that is being processed. For example, the first member 4 may directly support an ingot of the optical glass 10.

In the support member 3, the second member 5 supports the first member 4 in a manner that the first member 4 is hanging by the second member 5. The glass rod 11 supported by the support member 3 is rotatable. Note that a detailed description will be given later about a support structure by which the second member 5 supports the first member 4.

The raw material supplier 7 supplies a raw material (e.g., SiClO₄, H₂, or O₂) of the optical glass 10 toward the glass rod 11. The raw material supplier 7 also supplies a gas containing a halogen element (e.g., F₂ gas, Cl₂ gas, GeCl₄ gas, or Br₂ gas) as a raw material of an additive element of the optical glass 10 toward the glass rod 11. The raw material supplier 7 is movable inside the high temperature furnace 2.

As illustrated in FIG. 1, the optical glass 10 is formed on the surface of the glass rod 11 by supplying the raw material of the optical glass 10 from the raw material supplier 7 toward the glass rod 11 that is the starting material while maintaining the inside of the high temperature furnace 2 at a predetermined temperature.

As illustrated in FIG. 2, the optical glass 10 grows in the periphery of the glass rod 11 by moving the raw material supplier 7 appropriately while rotating the glass rod 11 using the support member 3.

In the first embodiment, examples of the optical glass 10 include a microlens, a photomask, a selective absorption transmission glass, or an optical fiber.

In the production process of the optical glass 10, various characteristics (e.g., index of refraction) of the optical glass 10 can be controlled by setting the inside of the high temperature furnace 2 to a high temperature environment of from 1100° C. to 1600° C. and supplying a gas containing a halogen element from the raw material supplier 7.

In the first embodiment described above, the support member 3 includes the first member 4 directly or indirectly supporting the optical glass 10, and the second member 5 supporting the first member 4. As such, when the support member 3 is corroded by a corrosive gas during the processing of the optical glass 10, the processing of the optical glass 10 can be continued by replacing only the first member 4, in which the corrosion reaction has progressed because the first member 4 is close to the optical glass 10.

That is, in the first embodiment, even when the support member 3 is corroded, the processing of the optical glass 10 can be continued simply by replacing a part (the first member 4) of the support member 3, making it possible to reduce the cost of replacing the support member 3. Thus, according to the first embodiment, the production cost of the optical glass 10 can be reduced.

In the present disclosure, “corrosion” is a phenomenon in which the weight of the member decreases and the porosity of the member increases simultaneously, by reacting with a gas containing a halogen element.

In the first embodiment, the first member 4 of the support member 3 may contain a dense ceramic having silicon nitride (Si3N4) as a main constituent. This allows the first member 4 to have improved corrosion resistance to a gas containing a halogen element in a high temperature environment of 1100° C. or higher, for example.

As such, according to the first embodiment, the frequency of replacing the first member 4 can be reduced, making it possible to further reduce the production cost of the optical glass 10.

In the first embodiment, the second member 5 of the support member 3 may contain a dense ceramic having silicon nitride as a main constituent. This allows the second member 5 to have improved corrosion resistance to a gas containing a halogen element in a high temperature environment of 1100° C. or higher, for example.

As such, according to the first embodiment, the frequency of replacing the second member 5 can be reduced, making it possible to further reduce the production cost of the optical glass 10. Note that in the first embodiment, the second member 5 is disposed further away from the optical glass 10 compared to the first member 4; as such, the second member 5 does not necessarily need to contain silicon nitride, and may contain, for example, a metal.

In the first embodiment, when at least one of the first member 4 or the second member 5 contains a dense ceramic having silicon nitride as a main constituent, a porosity of a surface layer of the dense ceramic is preferably less than a porosity of an inner portion of the dense ceramic.

When the support member 3 contains such a dense ceramic, a corrosive gas containing a halogen element can be less likely to enter the inner portion from a pore in the surface layer that is directly exposed to the corrosive gas. The surface layer may be a region within 2 mm in the depth direction from the surface. The inner portion may be a region deeper than 2 mm in the depth direction from the surface.

Thus, according to the first embodiment, the corrosion of the inner portion of the dense ceramic caused by a corrosive gas can be suppressed; as such, the support member 3 can have improved corrosion resistance.

In the first embodiment, the porosity of the inner portion of the dense ceramic is greater than the porosity of the surface layer of the dense ceramic, enabling the propagation of a crack from the surface layer to be stopped by a pore in the inner portion; as such, the support member 3 can have improved thermal shock resistance.

In the first embodiment, the porosity of the inner portion of the dense ceramic is greater than the porosity of the surface layer of the dense ceramic, enabling the coefficient of thermal conductivity in the inner portion to be reduced; as such, the escape of heat from the glass rod 11 via the support member 3 can be suppressed.

Thus, according to the first embodiment, the optical glass 10 formed on the glass rod 11 can have stabilized temperature, enabling stable production of the optical glass 10.

Note that in the first embodiment, when at least one of the first member 4 or the second member 5 contains a dense ceramic having silicon nitride as a main constituent, the porosity of the surface layer of the dense ceramic is preferably from 1(area %) to 3 (area %).

When the support member 3 contains such a dense ceramic having a small porosity in the surface layer, a corrosive gas containing a halogen element can be less likely to enter further into the inner portion from a pore.

As such, according to the first embodiment, the corrosion of the inner portion of the dense ceramic caused by a corrosive gas can be further suppressed; as such, the support member 3 can have further improved corrosion resistance.

In the first embodiment, when at least one of the first member 4 or the second member 5 contains a dense ceramic having silicon nitride as a main constituent, the porosity of the inner portion of the dense ceramic is preferably from 4 (area %) to 9 (area %).

When the support member 3 contains such a dense ceramic having a relatively large porosity in the inner portion, the support member 3 can have further improved thermal shock resistance, and the optical glass 10 can be produced even more stably.

In the first embodiment, when at least one of the first member 4 or the second member 5 contains a dense ceramic having silicon nitride as a main constituent, an average crystal grain size of the surface layer of the dense ceramic is preferably greater than an average crystal grain size of the inner portion of the dense ceramic.

When the support member 3 contains such a dense ceramic, the total length of the crystal grain boundaries in the surface layer of the dense ceramic can be shortened; as such, a corrosive gas containing a halogen element can be less likely to enter the inner portion of the dense ceramic from the crystal grain boundaries.

Thus, according to the first embodiment, the corrosion of the inner portion of the dense ceramic caused by a corrosive gas can be suppressed; as such, the support member 3 can have improved corrosion resistance.

In the first embodiment, when at least one of the first member 4 or the second member 5 contains a dense ceramic having silicon nitride as a main constituent, an oxygen content of the surface layer of the dense ceramic is preferably less than an oxygen content of the inner portion of the dense ceramic.

The support member 3 containing such a dense ceramic can suppress the reaction between a gas containing a halogen element (e.g., chlorine), which easily reacts with oxygen, and the oxygen present in the surface layer of the dense ceramic.

Thus, according to the first embodiment, the corrosion of the surface layer of the dense ceramic caused by a corrosive gas that easily reacts with oxygen can be suppressed; as such, the support member 3 can have improved corrosion resistance.

Note that in the first embodiment, when at least one of the first member 4 or the second member 5 contains a dense ceramic having silicon nitride as a main constituent, the oxygen content of the surface layer of the dense ceramic is preferably 7.0 (mass %) or less, more preferably 6.5 (mass %) or less.

This further suppresses the corrosion of the surface layer of the dense ceramic caused by a corrosive gas that easily reacts with oxygen, enabling further improvement of the corrosion resistance of the support member 3. In the first embodiment, an oxygen content of the inner portion of the dense ceramic is preferably 7.1 (mass %) or more.

In the first embodiment, when at least one of the first member 4 or the second member 5 contains a dense ceramic having silicon nitride as a main constituent, an aluminum content of the surface layer of the dense ceramic is preferably less than an aluminum content of the inner portion of the dense ceramic.

The support member 3 containing such a dense ceramic can suppress the reaction between a gas containing a halogen element (e.g., chlorine), which easily reacts with aluminum, and the aluminum present in the surface layer of the dense ceramic.

Thus, according to the first embodiment, the corrosion of the surface layer of the dense ceramic caused by a corrosive gas that easily reacts with aluminum can be suppressed; as such, the support member 3 can have improved corrosion resistance.

Note that in the dense ceramic that is contained in the support member 3, alumina (Al₂O₃) is used as a sintering aid in the sintering of silicon nitride that is a main component; as such, oxygen and aluminum atoms are present in the surface layer and the inner portion of the dense ceramic. v

Details of support structure

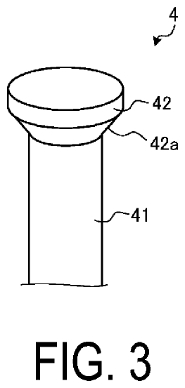

Next, a detailed description will be given about a support structure by which the second member 5 supports the first member 4 in the first embodiment with reference to FIGS. 3 to 6. As a diagram for describing a configuration of the first member 4 according to the first embodiment, FIG. 3 is an enlarged view of an upper end portion (i.e., a portion supported by the second member 5) of the first member 4.

As illustrated in FIG. 3, the first member 4 includes a body portion 41 and an enlarged-diameter portion 42. The body portion 41 is a columnar portion having, for example, a cylindrical shape. The enlarged-diameter portion 42 is provided at an upper end portion of the body portion 41 and has a larger outer diameter compared to that of the body portion 41.

The enlarged-diameter portion 42 includes a contact portion 42a having a tapered shape at a portion connected to the body portion 41. The contact portion 42a is in contact with the second member 5 when the second member 5 supports the first member 4.

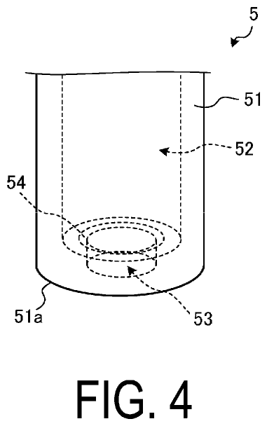

As a diagram for describing a configuration of the second member 5 according to the first embodiment, FIG. 4 is an enlarged view of a lower end portion (i.e., a portion supporting the first member 4) of the second member 5. As illustrated in FIG. 4, the second member 5 includes a body portion 51, a cavity portion 52, an opening portion 53, and a locking portion 54.

The body portion 51 is a columnar portion having, for example, a cylindrical shape. Formed in an inner portion of the body portion 51, the cavity portion 52 is a cylindrical cavity that extends in the same direction as the longitudinal direction of the body portion 51. Note that an inner diameter of the cavity portion 52 is greater than an outer diameter of the body portion 41 of the first member 4 and greater than an outer diameter of the enlarged-diameter portion 42 of the first member 4.

The opening portion 53 has a cylindrical shape and penetrates between the cavity portion 52 and a bottom surface 51a of the body portion 51. Note that an inner diameter of the opening portion 53 is smaller than the inner diameter of the cavity portion 52. An inner diameter of the opening portion 53 is greater than the outer diameter of the body portion 41 of the first member 4 but smaller than the outer diameter of the enlarged-diameter portion 42 of the first member 4.

The locking portion 54 is a portion having a tapered shape adjacent to the upper end of the opening portion 53. When the second member 5 supports the first member 4, the locking portion 54 is in contact with the contact portion 42a of the first member 4.

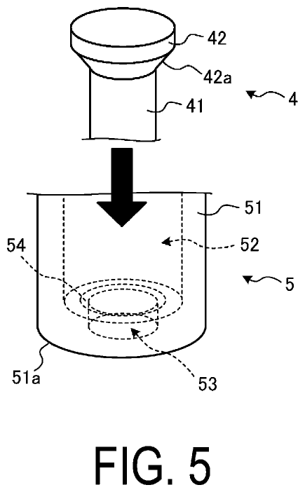

FIG. 5 is a diagram for describing a support method by which the second member 5 supports the first member 4 in the first embodiment. As illustrated in FIG. 5, if the second member 5 is to support the first member 4, the entire first member 4 is inserted downward into the cavity portion 52 of the second member 5.

Note that in this case, the first member 4 is inserted into the cavity portion 52 of the second member 5 with the enlarged-diameter portion 42 of the first member 4 facing upward and the opening portion 53 of the second member 5 facing downward. The body portion 41 of the first member 4 is inserted all the way into the opening portion 53 of the second member 5.

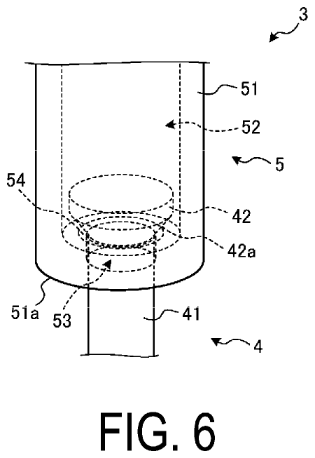

Here, in the first embodiment, the outer diameter of the enlarged-diameter portion 42 is greater than the inner diameter of the opening portion 53; thus, as illustrated in FIG. 6, the first member 4 is supported by the second member 5 without the entire first member 4 falling out from the second member 5. FIG. 6 is a diagram for describing a support structure by which the second member 5 supports the first member 4 in the first embodiment.

In the first embodiment, the contact portion 42a of the first member 4 is in contact with the locking portion 54 of the second member 5; thus, the first member 4 is supported by the second member 5 while these engaging portions are not fixed by an adhesive or the like. This allows the first member 4 to swing with respect to the second member 5.

As such, even if the second member 5 is fixed in a tilted position, the second member 5 can support the first member 4 substantially vertically. Thus, according to the first embodiment, the glass rod 11 supported by the first member 4 can also be supported substantially vertically, and thus the optical glass 10 can be grown stably in the periphery of the glass rod 11.

In the first embodiment, at least one of the contact portion 42a of the first member 4 or the locking portion 54 of the second member 5 preferably has a tapered shape or a spherical shape. This allows the first member 4 to swing more easily with respect to the second member 5.

As such, according to the first embodiment, even when the second member 5 is fixed in a tilted position, the first member 4 and the glass rod 11 can be more easily supported substantially vertically, and thus the optical glass 10 can be grown more stably in the periphery of the glass rod 11.

### Variations of First Embodiment

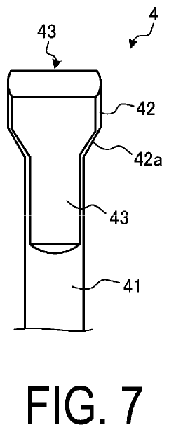

Next, variations of the first embodiment will be described with reference to FIG. 7 to FIG. 11. As a diagram for describing a configuration of a first member 4 according to Variation 1 of the first embodiment, FIG. 7 is an enlarged view of an upper end portion (i.e., a portion supported by a second member 5) of the first member 4.

As illustrated in FIG. 7, the first member 4 of Variation 1 of the first embodiment includes a body portion 41, an enlarged-diameter portion 42, and a pair of cutout portions 43. The body portion 41 is a columnar portion having, for example, a cylindrical shape. The enlarged-diameter portion 42 is provided at an upper end portion of the body portion 41 and has a portion having a larger outer diameter compared to that of the body portion 41.

The enlarged-diameter portion 42 includes a contact portion 42a having a tapered shape at a portion connected to the body portion 41. The contact portion 42a is in contact with the second member 5 when the second member 5 supports the first member 4.

The cutout portion 43 is a straight cutout extending from the enlarged-diameter portion 42 to an upper portion of the body portion 41 of the first member 4. The pair of cutout portions 43 are substantially parallel to each other.

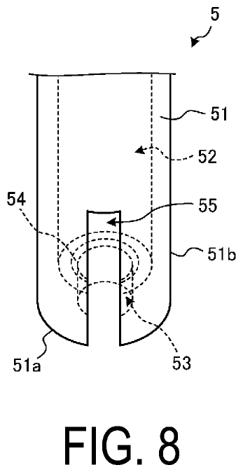

As a diagram for describing a configuration of the second member 5 according to Variation 1 of the first embodiment, FIG. 8 is an enlarged view of a lower end portion (i.e., a portion supporting the first member 4) of the second member 5. As illustrated in FIG. 8, the second member 5 of Variation 1 of the first embodiment includes a body portion 51, a cavity portion 52, an opening portion 53, a locking portion 54, and a slit 55.

The body portion 51 is a columnar portion having, for example, a cylindrical shape. Formed in the inner portion of the body portion 51, the cavity portion 52 is a cylindrical cavity that extends in the same direction as the longitudinal direction of the body portion 51. Note that an inner diameter of the cavity portion 52 is greater than a major axis of the body portion 41 and the enlarged-diameter portion 42 of the first member 4 (i.e., the outer diameter of the portion not cut away by the cutout portions 43).

The opening portion 53 has a cylindrical shape and penetrates between the cavity portion 52 and a bottom surface 51a of the body portion 51. Note that an inner diameter of the opening portion 53 is smaller than the inner diameter of the cavity portion 52. Also, the inner diameter of the opening portion 53 is greater than the major axis of the body portion 41 of the first member 4 but smaller than the major axis of the enlarged-diameter portion 42 of the first member 4.

The locking portion 54 is a portion having a tapered shape adjacent to the upper end of the opening portion 53. When the second member 5 supports the first member 4, the locking portion 54 is in contact with the contact portion 42a of the first member 4.

Formed in a side surface 51b of the body portion 51, the slit 55 is connecting the cavity portion 52 and the opening portion 53. The slit 55 extends in the same direction as the longitudinal direction of the body portion 51.

Note that a width of the slit 55 is greater than a minor axis of the body portion 41 and the enlarged-diameter portion 42 of the first member 4 (i.e., the outer diameter of the portion cut away by the cutout portions 43) but smaller than the major axis of the body portion 41 and the enlarged-diameter portion 42.

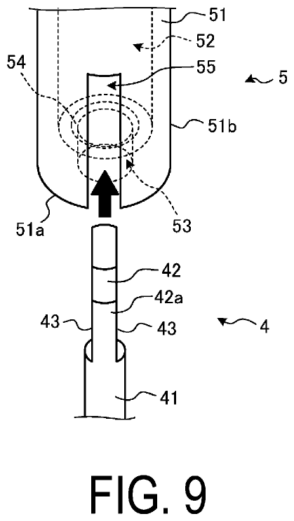

FIG. 9 is a diagram for describing a support method by which the second member 5 supports the first member 4 in Variation 1 of the first embodiment. As illustrated in FIG. 9, when the second member 5 is to support the first member 4, the portion with the cutout portions 43 at the upper end portion of the first member 4 is inserted sideways into the slit 55 of the second member 5.

Note that in this case, the upper end portion of the first member 4 is inserted into the slit 55 of the second member 5 with the enlarged-diameter portion 42 of the first member 4 facing upward and the opening portion 53 of the second member 5 facing downward. The enlarged-diameter portion 42 of the first member 4 is then inserted into the cavity portion 52 of the second member 5.

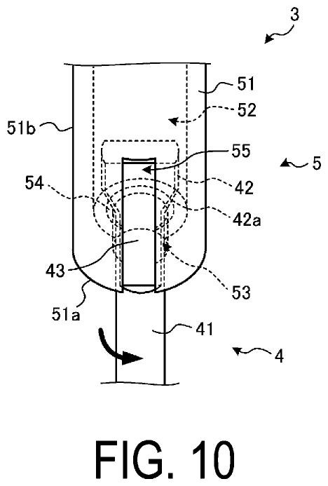

Here, in Variation 1 of the first embodiment, the enlarged-diameter portion 42 inserted into the cavity portion 52 is rotated, as illustrated in FIG. 10. This can restrain the enlarged-diameter portion 42 of the first member 4 from falling out from the second member 5, and thus the first member 4 is supported by the second member 5. FIG. 10 is a diagram for describing a support structure by which the second member 5 supports the first member 4 in Variation 1 of the first embodiment.

In Variation 1 of the first embodiment, the contact portion 42a of the first member 4 is in contact with the locking portion 54 of the second member 5; thus, the first member 4 is supported by the second member 5 while these engaging portions are not fixed by an adhesive or the like. This allows the first member 4 to swing with respect to the second member 5.

As such, even if the second member 5 is fixed in a tilted position, the second member can support the first member 4 substantially vertically. Thus, according to Variation 1 of the first embodiment, the glass rod 11 supported by the first member 4 can also be supported substantially vertically, and thus the optical glass 10 can be grown stably in the periphery of the glass rod 11.

In Variation 1 of the first embodiment, at least one of the contact portion 42a of the first member 4 or the locking portion 54 of the second member 5 preferably has a tapered shape or a spherical shape. This allows the first member 4 to swing more easily with respect to the second member 5.

As such, according to Variation 1 of the first embodiment, even when the second member 5 is fixed in a tilted position, the first member 4 and the glass rod 11 can be more easily supported substantially vertically, and thus the optical glass 10 can be grown more stably in the periphery of the glass rod 11.

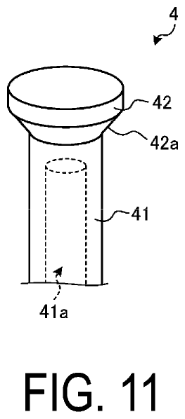

FIG. 11 is a diagram for describing a configuration of a first member 4 according to Variation 2 of the first embodiment. As illustrated in FIG. 11, in Variation 2 of the first embodiment, a hollow portion 41a that is a cavity is disposed in an inner portion of the body portion 41 of the first member 4. This makes it possible to reduce the weight of the first member 4, which is the hanging side, thus making it possible to reduce the load on a connecting portion connecting the first member 4 and the second member 5.

Uneven wear due to friction may appear at the connecting portion connecting the first member 4 and the second member 5. When the first member 4 is caught in a dent formed by such uneven wear, the first member 4 is less likely to swing with respect to the second member 5. This may make it difficult to support the glass rod 11 vertically.

However, in Variation 2 of the first embodiment, the hollow portion 41a is disposed in the first member 4, making it possible to reduce the load on the connecting portion connecting the first member 4 and the second member 5; thus, the likelihood that the first member 4 swings less with respect to the second member 5 can be suppressed.

### Second Embodiment

A member used in an optical glass production apparatus that manufactures optical glass (hereinafter, also referred to as a member for optical glass production apparatus) may be exposed to a corrosive gas in a high temperature environment in the process of producing such optical glass.

For example, in the process of producing optical glass, the above-described member may be exposed to a gas containing a halogen element [e.g., F (fluorine), Cl (chlorine), and Br (bromine)] in a high temperature environment of 1100° C. or higher.

Since corrosion reaction by a corrosive gas is promoted in such a harsh environment, a support member supporting the optical glass may be corroded. In the known art, the support member as a whole needs to be replaced when corroded. Such replacement causes an increase in the expenses, which in turn leads to a rise in the production cost of optical glass.

As such, a technique to overcome the aforementioned problem and reduce the production cost of optical glass awaits realization.

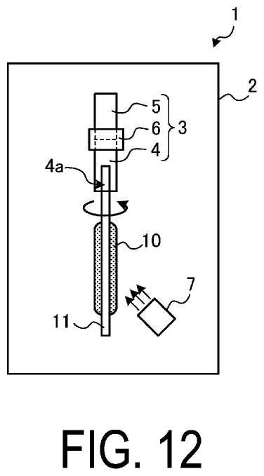

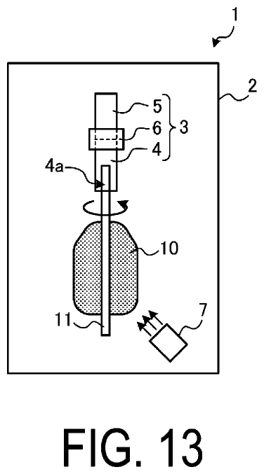

First, a configuration of an optical glass production apparatus 1 according to a second embodiment will be described with reference to FIGS. 12 and 13. FIGS. 12 and 13 are diagrams for describing a configuration of an optical glass production apparatus 1 according to the second embodiment.

FIG. 12 illustrates an initial stage in the production process of an optical glass 10, and FIG. 13 illustrates a later stage in the production process of the optical glass 10.

As illustrated in FIG. 12, the optical glass production apparatus 1 according to the second embodiment includes a high temperature furnace 2, a support member 3, and a raw material supplier 7. The support member 3 and the raw material supplier 7 are provided inside the high temperature furnace 2. The support member 3 is an example of a member for optical glass production apparatus.

The high temperature furnace 2 can form a high temperature environment (e.g., the temperature is from 1100° C. to 1600° C.) inside, which is required in a production process of the optical glass 10.

The support member 3 includes a first member 4, a second member 5, and a cover member 6. The support member 3 supports a glass rod 11, which is a starting material for the optical glass 10. In the first member 4, an insertion portion 4a through which the glass rod 11 can be inserted is formed, for example. The first member 4 supports the glass rod 11 in a manner that the glass rod 11 is hanging by the insertion portion 4a.

That is, in the second embodiment, the first member 4 indirectly supports the optical glass 10 that is being processed. Note that the support method by which the first member 4 supports the glass rod 11 is not limited to the above-described technique. In the second embodiment, the first member 4 may directly support the optical glass 10 that is being processed. For example, the first member 4 may directly support an ingot of the optical glass 10.

In the support member 3, the second member 5 supports the first member 4 in a manner that the first member 4 is hanging by the second member 5. The cover member 6 covers a connection portion connecting the first member 4 and the second member 5. The glass rod 11 supported by the support member 3 is rotatable. Note that details of the first member 4, the second member 5, and the cover member 6 will be described later.

The raw material supplier 7 supplies a raw material (e.g., SiClO₄, H₂, or O₂) of the optical glass 10 toward the glass rod 11. The raw material supplier 7 also supplies a gas containing a halogen element (e.g., F₂ gas, Cl₂ gas, GeCl₄ gas, or Br₂ gas) as a raw material of an additive element of the optical glass 10 toward the glass rod 11. The raw material supplier 7 is movable inside the high temperature furnace 2.

As illustrated in FIG. 12, the optical glass 10 is formed on the surface of the glass rod 11 by supplying the raw material of the optical glass 10 from the raw material supplier 7 toward the glass rod 11 that is the starting material while maintaining the inside of the high temperature furnace 2 at a predetermined temperature.

As illustrated in FIG. 13, the optical glass 10 grows in the periphery of the glass rod 11 by moving the raw material supplier 7 appropriately while rotating the glass rod 11 using the support member 3.

In the second embodiment, examples of the optical glass 10 include a microlens, a photomask, a selective absorption transmission glass, or an optical fiber.

In the production process of the optical glass 10, various characteristics (e.g., index of refraction) of the optical glass 10 can be controlled by setting the inside of the high temperature furnace 2 to a high temperature environment of from 1100° C. to 1600° C. and supplying a gas containing a halogen element from the raw material supplier 7.

In the second embodiment described above, the support member 3 includes the first member 4 directly or indirectly supporting the optical glass 10, the second member 5 supporting the first member 4, and the cover member 6 covering the connecting portion connecting the first member 4 and the second member 5.

As such, when the support member 3 is corroded by a corrosive gas during the processing of the optical glass 10, the processing of the optical glass 10 can be continued by replacing only the cover member 6, in which the corrosion reaction has progressed because the cover member 6 is close to the optical glass 10 and has a large specific surface area.

That is, in the second embodiment, even when the support member 3 is corroded, the processing of the optical glass 10 can be continued by simply replacing a part (the cover member 6) of the support member 3, making it possible to reduce the cost of replacing the support member 3. Thus, according to the second embodiment, the production cost of the optical glass 10 can be reduced.

In the present disclosure, “corrosion” is a phenomenon in which the weight of the member decreases and the porosity of the member increases simultaneously, by reacting with a gas containing a halogen element.

In the second embodiment, during the production of the optical glass 10, the cover member 6 can protect the connecting portion connecting the first member 4 and the second member 5 that is susceptible to corrosion due to external stress. Thus, according to the second embodiment, deterioration of the connecting portion can be suppressed.

In the second embodiment, the cover member 6 of the support member 3 may contain a dense ceramic having silicon nitride (Si₃N₄) as a main constituent. This allows the cover member 6 to have improved corrosion resistance to a gas containing a halogen element in a high temperature environment of 1100° C. or higher, for example.

As such, according to the second embodiment, the frequency of replacing the cover member 6 can be reduced, thus reducing the production cost of the optical glass 10.

In the second embodiment, the first member 4 of the support member 3 may contain a dense ceramic having silicon nitride (Si₃N₄) as a main constituent. This allows the first member 4 to have improved corrosion resistance to a gas containing a halogen element in a high temperature environment of 1100° C. or higher, for example.

As such, according to the second embodiment, the frequency of replacing the first member 4 can be reduced, thus reducing the production cost of the optical glass 10. Note that in the second embodiment, the first member 4 has a smaller specific surface area than that of the cover member 6; as such, the first member 4 does not necessarily need to contain silicon nitride, and may contain, for example, a metal.

In the second embodiment, the second member 5 of the support member 3 may contain a dense ceramic having silicon nitride as a main constituent. This allows the second member 5 to have improved corrosion resistance to a gas containing a halogen element in a high temperature environment of 1100° C. or higher, for example.

As such, according to the second embodiment, the frequency of replacing the second member 5 can be reduced, thus reducing the production cost of the optical glass 10. Note that in the second embodiment, the second member 5 is disposed further away from the optical glass 10 compared to the cover member 6; as such, the second member 5 does not necessarily need to contain silicon nitride, and may contain, for example, a metal or the like.

In addition, in the second embodiment, when at least one of the cover member 6, the first member 4, or the second member 5 contains a dense ceramic having silicon nitride as a main constituent, a porosity of a surface layer of the dense ceramic is preferably smaller than a porosity of an inner portion of the dense ceramic.

When the support member 3 contains such a dense ceramic, a corrosive gas containing a halogen element can be less likely to enter the inner portion from a pore in the surface layer that is directly exposed to the corrosive gas. The surface layer may be a region within 2 mm in the depth direction from the surface. The inner portion may be a region deeper than 2 mm in the depth direction from the surface.

Thus, according to the second embodiment, the corrosion of the inner portion of the dense ceramic caused by a corrosive gas can be suppressed; as such, the support member 3 can have improved corrosion resistance.

In the second embodiment, when the porosity of the inner portion of the dense ceramic is greater than the porosity of the surface layer of the dense ceramic, the propagation of a crack from the surface layer can be stopped by a pore in the inner portion; as such, the support member 3 can have improved thermal shock resistance.

In the second embodiment, when the porosity of the inner portion of the dense ceramic is greater than the porosity of the surface layer of the dense ceramic, the coefficient of thermal conductivity in the inner portion can be reduced; as such, the escape of heat from the glass rod 11 via the support member 3 can be suppressed.

Thus, according to the second embodiment, the optical glass 10 formed on the glass rod 11 can have stabilized temperature, enabling stable production of the optical glass 10.

Note that in the second embodiment, when at least one of the cover member 6, the first member 4, or the second member 5 contains a dense ceramic having silicon nitride as a main constituent, the porosity of the surface layer of the dense ceramic is preferably from 1 (area %) to 3 (area %).

When the support member 3 contains such a dense ceramic having a small porosity in the surface layer, a corrosive gas containing a halogen element can be less likely to enter further into the inner portion from a pore.

As such, according to the second embodiment, the corrosion of the inner portion of the dense ceramic caused by a corrosive gas can be further suppressed; as such, the support member 3 can have further improved corrosion resistance.

In the second embodiment, when at least one of the cover member 6, the first member 4, or the second member 5 contains a dense ceramic having silicon nitride as a main constituent, the porosity of the inner portion of the dense ceramic is preferably from 4 (area %) to 9 (area %).

When the support member 3 contains such a dense ceramic having a relatively large porosity in the inner portion, the support member 3 can have further improved thermal shock resistance, and the optical glass 10 can be produced even more stably.

In addition, in the second embodiment, when at least one of the cover member 6, the first member 4, or the second member 5 contains a dense ceramic having silicon nitride as a main constituent, an average crystal grain size of the surface layer of the dense ceramic is preferably larger than an average crystal grain size of the inner portion of the dense ceramic.

When the support member 3 contains such a dense ceramic, the total length of the crystal grain boundaries in the surface layer of the dense ceramic can be shortened; as such, a corrosive gas containing a halogen element can be less likely to enter the inner portion of the dense ceramic from the crystal grain boundaries.

Thus, according to the second embodiment, the corrosion of the inner portion of the dense ceramic caused by a corrosive gas can be suppressed; as such, the support member 3 can have improved corrosion resistance.

In the second embodiment, when at least one of the cover member 6, the first member 4, or the second member 5 contains a dense ceramic having silicon nitride as a main constituent, an oxygen content of the surface layer of the dense ceramic is preferably less than an oxygen content of the inner portion of the dense ceramic.

The support member 3 containing such a dense ceramic can suppress the reaction between a gas containing a halogen element (e.g., chlorine), which easily reacts with oxygen, and the oxygen present in the surface layer of the dense ceramic.

Thus, according to the second embodiment, the corrosion of the surface layer of the dense ceramic caused by a corrosive gas that easily reacts with oxygen can be suppressed; as such, the support member 3 can have improved corrosion resistance.

Note that in the second embodiment, when at least one of the cover member 6, the first member 4, or the second member 5 contains a dense ceramic having silicon nitride as a main constituent, the oxygen content of the surface layer of the dense ceramic is preferably 7.0 (mass %) or less, more preferably 6.5 (mass %) or less.

This further suppresses the corrosion of the surface layer of the dense ceramic caused by a corrosive gas that easily reacts with oxygen, enabling further improvement of the corrosion resistance of the support member 3. In the second embodiment, an oxygen content of the inner portion of the dense ceramic is preferably 7.1 (mass %) or more.

In addition, in the second embodiment, when at least one of the cover member 6, the first member 4, or the second member 5 contains a dense ceramic having silicon nitride as a main constituent, an aluminum content of the surface layer of the dense ceramic is preferably less than an aluminum content of the inner portion of the dense ceramic.

The support member 3 containing such a dense ceramic can suppress the reaction between a gas containing a halogen element (e.g., chlorine), which easily reacts with aluminum, and the aluminum present in the surface layer of the dense ceramic.

Thus, according to the second embodiment, the corrosion of the surface layer of the dense ceramic caused by a corrosive gas that easily reacts with aluminum can be suppressed; as such, the support member 3 can have improved corrosion resistance.

Note that in the dense ceramic that is contained in the support member 3, alumina (Al₂O₃) is used as a sintering aid in the sintering of silicon nitride that is a main component; as such, oxygen and aluminum atoms are present in the surface layer and the inner portion of the dense ceramic.

Configuration of Support Member

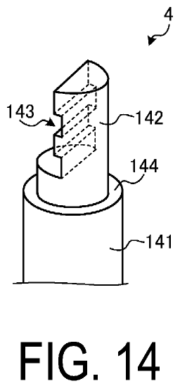

Next, a configuration of the support member 3 according to the second embodiment will be described in detail with reference to FIG. 14 to FIG. 18. As a diagram for describing a configuration of the first member 4 according to the second embodiment, FIG. 14 is an enlarged view of an upper end portion (i.e., a portion supported by the second member 5) of the first member 4.

As illustrated in FIG. 14, the first member 4 includes a body portion 141, a narrowed-diameter portion 142, a stepped portion 143, and a support portion 144. The body portion 141 is a columnar portion having, for example, a cylindrical shape. The narrowed-diameter portion 142 is provided at an upper end portion of the body portion 141 and has a smaller outer diameter than the body portion 141.

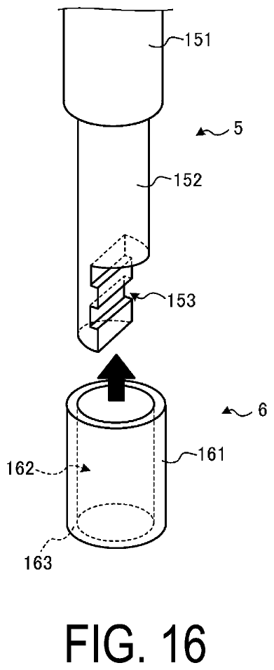

Formed on a side surface of the narrowed-diameter portion 142, the stepped portion 143 has steps of different heights that are facing a side. The support portion 144 is an annular flat surface located between the body portion 141 and the narrowed-diameter portion 142. When the first member 4 supports the cover member 6, the support portion 144 is in contact with a bottom surface 163 (see FIG. 16) of the cover member 6.

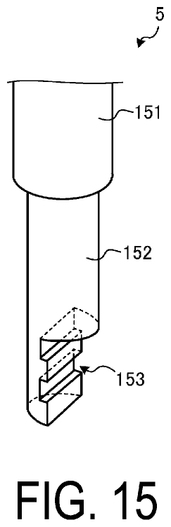

As a diagram for describing a configuration of the second member 5 according to the second embodiment, FIG. 15 is an enlarged view of a lower end portion (i.e., a portion supporting the first member 4) of the second member 5. As illustrated in FIG. 15, the second member 5 includes a body portion 151, a narrowed-diameter portion 152, and a stepped portion 153.

The body portion 151 is a columnar portion having, for example, a cylindrical shape. The narrowed-diameter portion 152 is provided at a lower end portion of the body portion 151 and has a smaller outer diameter than the body portion 151. An outer diameter of the narrowed-diameter portion 152 is substantially equal to the outer diameter of the narrowed-diameter portion 142 of the first member 4.

Formed on a side surface of the narrowed-diameter portion 152, the stepped portion 153 has steps of different heights that are facing a side. The stepped portion 153 has a shape that fits into the stepped shape of the stepped portion 143 of the first member 4.

FIG. 16 is a diagram for describing an installation method by which the cover member 6 is installed on the second member 5 according to the second embodiment. As illustrated in FIG. 16, the cover member 6 has a substantially cylindrical shape, and includes a body portion 161, a cavity portion 162, and the bottom surface 163.

The body portion 161 is a columnar portion having, for example, a cylindrical shape. Formed in an inner portion of the body portion 161, the cavity portion 162 is a cylindrical cavity that extends in the same direction as the longitudinal direction of the body portion 161.

Note that an inner diameter of the cavity portion 162 is greater than the outer diameter of the narrowed-diameter portion 142 of the first member 4 and greater than the outer diameter of the narrowed-diameter portion 152 of the second member 5. Also, the inner diameter of the cavity portion 162 is smaller than an outer diameter of the body portion 141 of the first member 4.

If the cover member 6 is to be installed on the second member 5, the cover member 6 is inserted upward onto the narrowed-diameter portion 152 of the second member 5. Here, in the second embodiment, the portion of the narrowed-diameter portion 152 that is disposed closer to a base end than the stepped portion 153 is longer than the cover member 6.

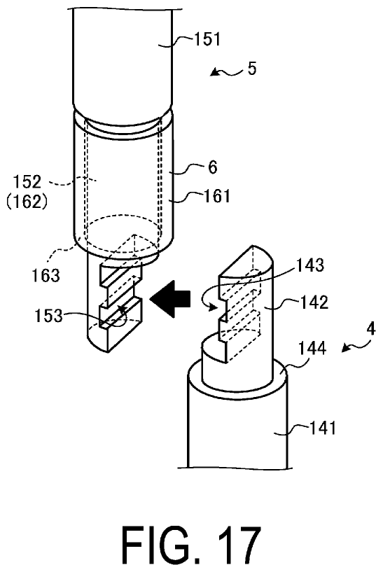

As a result, as illustrated in FIG. 17, when the cover member 6 is inserted upward onto the narrowed-diameter portion 152 of the second member 5, the stepped portion 153 of the second member 5 can be exposed from the cover member 6. FIG. 17 is a diagram for describing a support method by which the second member 5 supports the first member 4 in the second embodiment.

Next, if the second member 5 is to support the first member 4, the stepped portion 143 of the first member 4 is fitted sideways into the stepped portion 153 of the second member 5. Here, in the second embodiment, when the stepped portion 143 of the first member 4 is fitted into the stepped portion 153 of the second member 5, the narrowed-diameter portion 142 of the first member 4 and the narrowed-diameter portion 152 of the second member 5 become a cylinder having an even outer diameter.

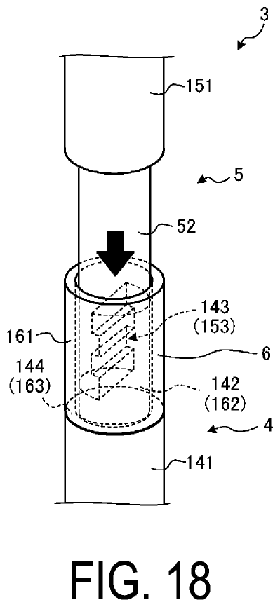

As a result, as illustrated in FIG. 18, the cover member 6 can be inserted onto the narrowed-diameter portion 142 of the first member 4. In the second embodiment, the cover member 6 is longer than the narrowed-diameter portion 142 of the first member 4; as such, when the bottom surface 163 of the cover member 6 is supported by the support portion 144 of the first member 4, the connecting portion (here, the stepped portions 143 and 153, as well as the periphery thereof) connecting the first member 4 and the second member 5 can be covered with the cover member 6.

As a result, during the production the optical glass 10 (see FIG. 1), the cover member 6 can protect the connecting portion (stepped portions 143 and 153) that is susceptible to corrosion due to external stress. Thus, according to the second embodiment, deterioration of the connecting portion can be suppressed.

In the second embodiment, when the support member 3 is corroded by a corrosive gas during the processing of the optical glass 10, the processing of the optical glass 10 can be continued by replacing only the cover member 6, in which the corrosion reaction has progressed because the cover member 6 is close to the optical glass 10 and has a large specific surface area.

That is, in the second embodiment, even when the support member 3 is corroded, the processing of the optical glass 10 can be continued by simply replacing a part (the cover member 6) of the support member 3, making it possible to reduce the cost of replacing the support member 3. Thus, according to the second embodiment, the production cost of the optical glass 10 can be reduced.

Variations of second embodiment

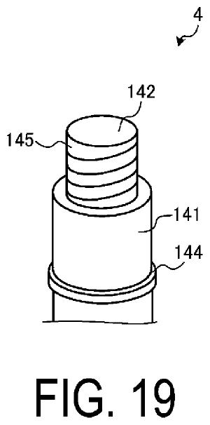

Next, variations of the second embodiment will be described with reference to FIGS. 19 to 32. Note that, in the variations below, parts that are the same as those in the second embodiment will be denoted by the same reference numerals, and redundant explanations may be omitted.

As a diagram for describing a configuration of a first member 4 according to Variation 1 of the second embodiment, FIG. 19 is an enlarged view of an upper end portion (i.e., a portion supported by a second member 5) of the first member 4. As illustrated in FIG. 19, the first member 4 of Variation 1 of the second embodiment includes a body portion 141, a narrowed-diameter portion 142, a support portion 144, and an external thread portion 145.

The body portion 141 is a columnar portion having, for example, a cylindrical shape. The narrowed-diameter portion 142 is provided at an upper end portion of the body portion 141 and has a smaller outer diameter than the body portion 141. The support portion 144 is an annular protrusion provided at a predetermined location on a side surface of the body portion 141.

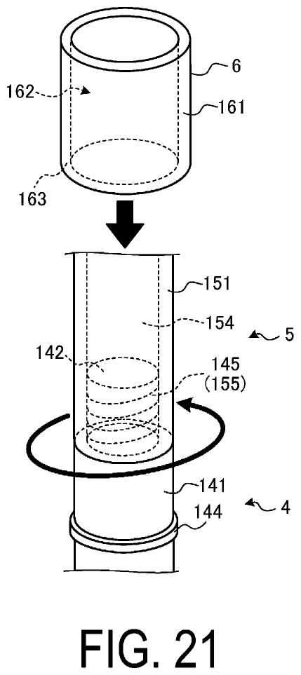

When the first member 4 supports a cover member 6, the support portion 144 is in contact with a bottom surface 163 (see FIG. 21) of the cover member 6. The external thread portion 145 is a spiral groove formed on a side surface of the narrowed-diameter portion 142, and functions as an external thread.

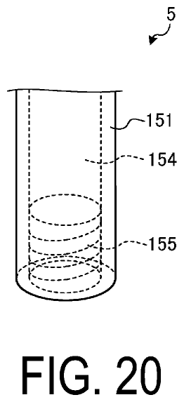

As a diagram for describing a configuration of the second member 5 according to Variation 1 of the second embodiment, FIG. 20 is an enlarged view of a lower end portion (i.e., a portion supporting the first member 4) of the second member 5. As illustrated in FIG. 20, the second member 5 of Variation 1 of the second embodiment includes a body portion 151, a cavity portion 154, and an internal thread portion 155.

The body portion 151 is a columnar portion having, for example, a cylindrical shape. An outer diameter of the body portion 151 is substantially the same as an outer diameter of the body portion 141 of the first member 4. Formed in an inner portion of the body portion 151, the cavity portion 154 is a cylindrical cavity that extends in the same direction as the longitudinal direction of the body portion 151.

The internal thread portion 155 is a spiral groove formed on an inner side surface on a tip end side of the cavity portion 154, and functions as an internal thread to which the external thread portion 145 of the first member 4 can be threadably coupled.

FIG. 21 is a diagram for describing a support method by which the second member 5 supports the first member 4 in Variation 1 of the second embodiment. As illustrated in FIG. 21, if the second member 5 is to support the first member 4, the external thread portion 145 of the first member 4 is threadably coupled to the internal thread portion 155 of the second member 5.

As illustrated in FIG. 21, the cover member 6 of Variation 1 of the second embodiment has a substantially cylindrical shape, and includes a body portion 161, a cavity portion 162, and the bottom surface 163.

The body portion 161 is a columnar portion having, for example, a cylindrical shape. Formed in an inner portion of the body portion 161, the cavity portion 162 is a cylindrical cavity that extends in the same direction as the longitudinal direction of the body portion 161.

Note that an inner diameter of the cavity portion 162 is slightly greater than the outer diameter of the body portion 141 of the first member 4 and slightly greater than the outer diameter of the body portion 151 of the second member 5. The inner diameter of the cavity portion 162 is smaller than an outer diameter of the support portion 144 of the first member 4.

If the cover member 6 is to be installed on the first member 4 and the second member 5, the cover member 6 is inserted downward onto the body portion 151 of the second member 5. Here, in Variation 1 of the second embodiment, the length from the support portion 144 of the first member 4 to the tip end portion of the second member 5 is shorter than that of the cover member 6.

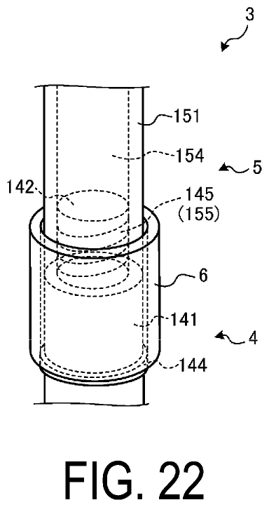

As such, in Variation 1 of the second embodiment, when the bottom surface 163 of the cover member 6 is supported by the support portion 144 of the first member 4, as illustrated in FIG. 22, the connecting portion (here, the tip end portion of the second member 5 and the periphery thereof) connecting the first member 4 and the second member 5 can be covered with the cover member 6. FIG. 22 is a diagram for describing a structure of a support member 3 according to Variation 1 of the second embodiment.

As a result, during the production the optical glass 10 (see FIG. 1), the cover member 6 can protect the connecting portion (the tip end portion of the second member 5) that is susceptible to corrosion due to external stress. Thus, according to Variation 1 of the second embodiment, deterioration of the connecting portion can be suppressed.

In Variation 1 of the second embodiment, when the support member 3 is corroded by a corrosive gas during the processing of the optical glass 10, the processing of the optical glass 10 can be continued by replacing only the cover member 6, in which the corrosion reaction has progressed because the cover member 6 is close to the optical glass 10 and has a large specific surface area.

That is, in Variation 1 of the second embodiment, even when the support member 3 is corroded, the processing of the optical glass 10 can be continued by simply replacing a part (the cover member 6) of the support member 3, making it possible to reduce the cost of replacing the support member 3. Thus, according to Variation 1 of the second embodiment, the production cost of the optical glass 10 can be reduced.

As a diagram for describing a configuration of a first member 4 according to Variation 2 of the second embodiment, FIG. 23 is an enlarged view of an upper end portion (i.e., a portion supported by a second member 5) of the first member 4. As illustrated in FIG. 23, the first member 4 of Variation 2 of the second embodiment includes a body portion 141, a narrowed-diameter portion 142, and an external thread portion 145.

In other words, the first member 4 of Variation 2 of the second embodiment is the same and/or similar to the first member 4 of Variation 1 of the second embodiment except that the support portion 144 is not provided, and thus detailed description is omitted.

As a diagram for describing a configuration of the second member 5 according to Variation 2 of the second embodiment, FIG. 24 is an enlarged view of a lower end portion (i.e., a portion supporting the first member 4) of the second member 5. As illustrated in FIG. 24, the second member 5 of Variation 1 of the second embodiment includes a body portion 151, a cavity portion 154, an internal thread portion 155, and a support portion 156.

Note that the body portion 151, the cavity portion 154, and the internal thread portion 155 of Variation 2 of the second embodiment are the same and/or similar to the body portion 151, the cavity portion 154, and the internal thread portion 155 of the second member 5 of Variation 1 of the second embodiment, and thus detailed description is omitted.

The support portion 156 is an annular protrusion provided at a predetermined location on a side surface of the body portion 151. When the second member 5 supports a cover member 6, the support portion 156 is in contact with a protruding portion 164 (see FIG. 25) of the cover member 6.

FIG. 25 is a diagram for describing a support method by which the second member 5 supports the first member 4 in Variation 2 of the second embodiment. As illustrated in FIG. 25, if the second member 5 is to support the first member 4, the external thread portion 145 of the first member 4 is threadably coupled to the internal thread portion 155 of the second member 5.

As illustrated in FIG. 25, the cover member 6 of Variation 2 of the second embodiment has a substantially cylindrical shape, and includes a body portion 161, a cavity portion 162, a bottom surface 163, and the protruding portion 164.

The body portion 161 is a columnar portion having, for example, a cylindrical shape. Formed in an inner portion of the body portion 161, the cavity portion 162 is a cylindrical cavity that extends in the same direction as the longitudinal direction of the body portion 161.

The protruding portion 164 is an annular protrusion provided at an upper end portion on an inner side surface of the body portion 161. That is, in the vicinity of the protruding portion 164, a cylindrical cavity having an inner diameter smaller than that of the cavity portion 162 is formed.

Note that the inner diameter of the cavity formed in the vicinity of the protruding portion 164 is slightly greater than an outer diameter of the body portion 151 of the second member 5. The inner diameter of the cavity is smaller than an outer diameter of the support portion 156 of the second member 5.

If the cover member 6 is to be installed on the first member 4 and the second member 5, the cover member 6 is inserted downward onto the body portion 151 of the second member 5. Here, in Variation 2 of the second embodiment, the length from the support portion 156 of the second member 5 to the tip end portion of the second member 5 is shorter than that of the cover member 6.

As such, in Variation 2 of the second embodiment, when the protruding portion 164 of the cover member 6 is supported by the support portion 156 of the second member 5, as illustrated in FIG. 26, the connecting portion (here, the tip end portion of the second member 5 and the periphery thereof) connecting the first member 4 and the second member 5 can be covered with the cover member 6. FIG. 26 is a diagram for describing a structure of a support member 3 according to Variation 2 of the second embodiment.

As a result, during the production the optical glass 10 (see FIG. 12), the cover member 6 can protect the connecting portion (the tip end portion of the second member 5) that is susceptible to corrosion due to external stress. Thus, according to Variation 2 of the second embodiment, deterioration of the connecting portion can be suppressed.

In Variation 2 of the second embodiment, when the support member 3 is corroded by a corrosive gas during the processing of the optical glass 10, the processing of the optical glass 10 can be continued by replacing only the cover member 6, in which the corrosion reaction has progressed because the cover member 6 is close to the optical glass 10 and has a large specific surface area.

That is, in Variation 2 of the second embodiment, even when the support member 3 is corroded, the processing of the optical glass 10 can be continued by simply replacing a part (the cover member 6) of the support member 3, making it possible to reduce the cost of replacing the support member 3. Thus, according to Variation 2 of the second embodiment, the production cost of the optical glass 10 can be reduced.

As a diagram for describing a labyrinth structure inside the support member 3 according to Variation 2 of the second embodiment, FIG. 27 is a cross-sectional view illustrating the vicinity of the support portion 156 of the second member 5. As illustrated in FIG. 27, in Variation 2, a labyrinth structure is preferably provided in the vicinity of the support portion 156 of the second member 5.

For example, on a side surface 151a of the body portion 151, projecting portions 151a1 are formed at sites above the support portion 156 of the second member 5 along the circumferential direction. On an inner side surface 164a of the protruding portion 164 of the cover member 6 facing the projecting portions 151a1, recessed portions 164a1 corresponding to the projecting portions 151a1 are formed.

On the opposing surfaces (the side surface 151a and the inner side surface 164a) of the second member 5 and the cover member 6 that are facing each other, a labyrinth structure is formed by the projecting portions 151a1 of the second member 5 and the recessed portions 164a1 of the cover member 6.

This makes it possible to suppress the entry of a corrosive gas into the connecting portion connecting the first member 4 and the second member 5 through a gap formed between the second member 5 and the cover member 6. Thus, according to Variation 2 of the second embodiment, deterioration of the connecting portion can be further suppressed.

Note that the labyrinth structure formed between the second member 5 and the cover member 6 is not limited to the example illustrated in FIG. 27, and the labyrinth structure may be any structure that complicates the entry path of a corrosive gas.

As a diagram for describing a configuration of a first member 4 according to Variation 3 of the second embodiment, FIG. 28 is an enlarged view of an upper end portion (i.e., a portion supported by a second member 5) of the first member 4. As illustrated in FIG. 28, the first member 4 includes a body portion 141, a narrowed-diameter portion 142, a stepped portion 143, a support portion 144, and an external thread portion 146.

Note that the body portion 141, the narrowed-diameter portion 142, the stepped portion 143, and the support portion 144 of Variation 3 of the second embodiment are the same and/or similar to the body portion 141, the narrowed-diameter portion 142, the stepped portion 143, and the support portion 144 of the first member 4 of the second embodiment, and thus detailed description is omitted. The external thread portion 146 is a spiral groove formed on a side surface of the narrowed-diameter portion 142, and functions as an external thread.

FIG. 29 is a diagram for describing an installation method by which a cover member 6 is installed on the second member 5 according to Variation 3 of the second embodiment. As illustrated in FIG. 29, the second member 5 of Variation 3 of the second embodiment includes a body portion 151, a narrowed-diameter portion 152, and a stepped portion 153. Note that the first member 4 of Variation 3 of the second embodiment is the same and/or similar to the second member 5 of the second embodiment, and thus detailed description is omitted.

The cover member 6 of Variation 3 of the second embodiment has a substantially cylindrical shape, and includes a body portion 161, a cavity portion 162, a bottom surface 163, and an internal thread portion 165. Note that the body portion 161, the cavity portion 162, and the bottom surface 163 of Variation 3 of the second embodiment are the same and/or similar to the body portion 161, the cavity portion 162, and the bottom surface 163 of the cover member 6 of the second embodiment, and thus detailed description is omitted.

The internal thread portion 165 is a spiral groove formed on an inner side surface on a lower end side of the cavity portion 162, and functions as an internal thread to which the external thread portion 146 of the first member 4 can be threadably coupled.

If the cover member 6 is to be installed on the second member 5, the cover member 6 is inserted upward onto the narrowed-diameter portion 152 of the second member 5. Here, in Variation 3 of the second embodiment, the portion of the narrowed-diameter portion 152 that is disposed closer to a base end than the stepped portion 153 is longer than the cover member 6.

As a result, as illustrated in FIG. 17 of the second embodiment, when the cover member 6 is inserted upward onto the narrowed-diameter portion 152 of the second member 5, the stepped portion 153 of the second member 5 can be exposed from the cover member 6.

Next, as illustrated in FIG. 17 of the second embodiment, if the second member is to support the first member 45, the stepped portion 143 of the first member 4 is fitted sideways into the stepped portion 153 of the second member 5.

As a result, as illustrated in FIG. 30, the cover member 6 can be inserted onto the narrowed-diameter portion 142 of the first member 4. FIG. 30 is a diagram for describing a structure of a support member 3 according to Variation 3 of the second embodiment.

In Variation 3 of the second embodiment, the cover member 6 is longer than the narrowed-diameter portion 142 of the first member 4; as such, when the bottom surface 163 of the cover member 6 is supported by the support portion 144 of the first member 4, the connecting portion (here, the stepped portions 143 and 153, as well as the periphery thereof) connecting the first member 4 and the second member 5 can be covered with the cover member 6.

In this way, the connecting portion (the stepped portions 143 and 153) connecting the first member 4 and the second member 5 are covered with the cover member 6; as a result, during the production the optical glass 10 (see FIG. 12), the cover member 6 can protect the connecting portion that is susceptible to corrosion due to external stress.

In Variation 3 of the second embodiment, if the first member 4 is to support the cover member 6, the internal thread portion 165 of the cover member 6 is threadably coupled to the external thread portion 146 of the first member 4.

This makes it possible to suppress shifting of the cover member 6 covering the connecting portion connecting the first member 4 and the second member 5 due to disturbance or the like. Thus, according to Variation 3 of the second embodiment, deterioration of the connecting portion can be further suppressed.

In Variation 3 of the second embodiment, when the support member 3 is corroded by a corrosive gas during the processing of the optical glass 10, the processing of the optical glass 10 can be continued by replacing only the cover member 6, in which the corrosion reaction has progressed because the cover member 6 is close to the optical glass 10 and has a large specific surface area.

That is, in Variation 3 of the second embodiment, even when the support member 3 is corroded, the processing of the optical glass 10 can be continued by simply replacing a part (the cover member 6) of the support member 3, making it possible to reduce the cost of replacing the support member 3. Thus, according to Variation 3 of the second embodiment, the production cost of the optical glass 10 can be reduced.

In the second embodiment and variations described above, examples of using a stepped portion or threadably coupling are described as support methods by which the second member 5 supports the first member 4, but the support method by which the second member 5 supports the first member 4 is not limited to the examples.

FIG. 31 is a diagram for describing a support method by which the second member 5 supports the first member 4 in Variation 4 of the second embodiment. As illustrated in FIG. 31, in Variation 4 of the second embodiment, a hook portion 147 is provided at an upper end portion of a narrowed-diameter portion 142 of the first member 4 while a hook portion 157 is provided at a lower end portion of a narrowed-diameter portion 152 of the second member 5.

In Variation 4 of the second embodiment, the hook portion 147 of the first member 4 hooks to the hook portion 157 of the second member 5, and thus the second member 5 can support the first member 4. Thereafter, a connecting portion (here, the hook portions 147 and 157, and the periphery thereof) connecting the first member 4 and the second member 5 may be covered with a cover member 6 by using the techniques of the second embodiment and variations described above.

FIG. 32 is a diagram for describing a support method by which a second member 5 supports a first member 4 in Variation 5 of the second embodiment. As illustrated in FIG. 32, in Variation 5 of the second embodiment, a hook portion 147 is provided at an upper end portion of a narrowed-diameter portion 142 of the first member 4 while an arc portion 158 is provided at a lower end portion of a narrowed-diameter portion 152 of the second member 5.

In Variation 5 of the second embodiment, the hook portion 147 of the first member 4 hooks to the arc portion 158 of the second member 5, and thus the second member 5 can support the first member 4. Thereafter, a connecting portion (here, the hook portion 147, the arc portion 158, and the periphery thereof) connecting the first member 4 and the second member 5 may be covered with a cover member 6 by using the techniques of the second embodiment and variations described above.

### EXAMPLES

Examples of the present disclosure will be specifically described below. Note that in the examples described below, the support member 3 containing silicon nitride as a main constituent is described, but the present disclosure is not limited to the following examples.

First, a metal silicon powder having an average particle size of 3 μm, a silicon nitride powder having an average particle size of 1 μm and a beta ratio of 10% (i.e., alpha ratio of 90%), an alumina powder having an average particle size of 1 μm, and an yttria (Y₂O₃) powder having an average particle size of 1 μm were prepared. Each prepared powder was mixed at a predetermined ratio to yield a mixed powder.

The resulting mixed powder was then placed in a barrel mill with a grinding medium including water and a silicon nitride-based sintered compact and mixed and ground to a predetermined particle size. Then, a slurry was produced by adding polyvinyl alcohol (PVA), which is an organic binder, at a predetermined ratio to the mixed powder that had been mixed and ground.

The resulting slurry was then sieved through a mesh sieve having a predetermined particle size and then granulated using a spray-drying granulator to yield granules. The resulting granules were made into a predetermined shape by cold isotropic pressure (CIP) molding at a molding pressure of from 60 MPa to 100 MPa, resulting in a compact.

The resulting compact was then placed in a silicon carbide mortar and degreased by holding the compact at 500° C. for 5 hours in a nitrogen atmosphere. Subsequently, the temperature was increased further, and nitriding was carried out by successively holding the compact at 1050° C. for 20 hours and at 1250° C. for 10 hours, in a nitrogen partial pressure of 150 kPa substantially composed of nitrogen.

Then, the pressure of the nitrogen was set to normal pressure, the temperature was further increased, and the firing was performed at 1700° C. to 1800° C. for 2 hours or more. Finally, cooling at a predetermined temperature decrease rate was performed to produce a support portion 3 (first member 4 and second member 5) of a dense ceramic containing silicon nitride as a main constituent.

Note that, the insertion portion 4a was formed in the first member 4, and the cavity portion 52 was formed in the second member 5; as such, a tubular portion was present in any member constituting the support member 3.

Then, polished surfaces on an outer peripheral side (an example of the surface layer of the support member 3), at a center portion (an example of the inner portion of the support member 3), and on an inner peripheral side (an example of the surface layer of the support member 3) of the produced tubular support member 3 were observed by a scanning electron microscope (SEM).

FIGS. 33 to 35 are SEM observed photographs of the polished surfaces on the outer peripheral side, at the center portion, and on the inner peripheral side of the support member 3. In the SEM observed photographs of FIGS. 33 to 35, a portion in dark color is a pore.

Next, the number of pores per unit area for each observed portion, porosity, an average diameter of pores, and a maximum diameter of pores were evaluated using the obtained SEM observed photographs. Specifically, first, the contour of the pore detected in dark color is outlined in black using the taken SEM observed photograph.

Next, the number of pores per unit area, the average diameter of pores, and the maximum diameter of pores can be determined by performing image analysis by applying a technique called “particle analysis” provided by the image analysis software “Azo-kun” (trade name, product of Asahi Kasei Engineering Cooperation, hereinafter image analysis software “Azo-kun” is referred to image analysis software of Asahi Kasei Engineering Cooperation) using a bordered image or photograph.

By applying the particle analysis provided by the image analysis software “Azo-kun” to perform image analysis, a total area of a plurality of pores can be determined, and “porosity” can be determined based on the ratio of the total area of the plurality of pores to the unit area.

The fracture surfaces on the outer peripheral side, at the center portion, and on the inner peripheral side of the produced tubular support member 3 were observed by SEM. FIGS. 36 to 38 are SEM observed photographs of the fracture surfaces on the outer peripheral side, at the center portion, and on the inner peripheral side of the support member 3.

The produced tubular support member 3 was evaluated for the oxygen content and the aluminum content on the outer peripheral side, at the center portion, and on the inner peripheral side of the tubular support member 3. The oxygen content was evaluated by an infrared absorption method using an oxygen analyzer (EMGA-650FA manufactured by HORIBA, Ltd.). The aluminum content was evaluated using an inductively coupled plasma (ICP) emission spectrophotometer or an X-ray fluorescence spectrometer.

Here, Table 1 shows the evaluation results of the number of pores per unit area, the porosity, the average diameter of pores, the maximum diameter of pores, the oxygen content, and the aluminum content for each observed portion of the support member 3.

TABLE 1

| | NUMBER | | AVERAGE | MAXIMUM | | |
|---|---|---|---|---|---|---|
| | OF PORES | | DIAMETER | DIAMETER | OXYGEN | ALUMINUM |
| OBSERVED | PER UNIT | POROSITY | OF PORES | OF PORES | CONTENT | CONTENT |
| PORTION | AREA | (Area %) | (μm) | (μm) | (mass %) | (mass %) |
| OUTER | 3289 | 2.1 | 2.0 | 14.2 | 6.2 | 1.9 |
| PERIPHERAL | | | | | | |
| SIDE | | | | | | |
| CENTER | 2764 | 5.3 | 3.9 | 18.4 | 7.3 | 2.0 |
| PORTION | | | | | | |
| INNER | 1672 | 1.6 | 2.5 | 14.0 | 7.0 | 1.8 |
| PERIPHERAL | | | | | | |
| SIDE | | | | | | |

As shown in Table 1and FIGS. 33 to 35, in the support members 3 according to the embodiments, the porosity of the surface layer (i.e., the outer peripheral side and the inner peripheral side) was smaller than the porosity of the inner portion (i.e., the center portion). This can restrain the corrosive gas from entering the inside from the pore in the surface layer directly exposed to a corrosive gas containing the halogen element.

Thus, according to the embodiments, the corrosion of the inner portion of the support member 3 caused by a corrosive gas can be suppressed; as such, the support member 3 can have improved corrosion resistance.

Note that an effective technique for making the porosity of the surface layer of the support member 3 smaller than the porosity of the inner portion of the support member 3 is to perform CIP molding at a high molding pressure (from 60 MPa to 100 MPa) or to perform a firing process in a nitrogen atmosphere at the normal pressure.

As illustrated in FIGS. 36 to 38, in the support members 3 according to the embodiments, the average crystal grain size of the surface layer (i.e., the outer peripheral side and the inner peripheral side) was greater than the average crystal grain size of the inner portion (i.e., the center portion). This makes it possible to shorten the total length of the crystal grain boundaries in the surface layer, thereby making it difficult for the corrosive gas containing the halogen element to enter the inside from the crystal grain boundaries.

Thus, according to the embodiments, the corrosion of the inner portion of the support member 3 caused by a corrosive gas can be suppressed; as such, the support member 3 can have improved corrosion resistance.

Note that an effective technique for making the average crystal grain size of the surface layer of the support member 3 greater than the average crystal grain size of the inner portion of the support member 3 is to perform a firing process at a temperature of from 1700° C. to 1800° C. for 2 hours or more.

As shown in Table 1, in the support members 3 according to the embodiments, oxygen content of the surface layer (i.e., the outer peripheral side and the inner peripheral side) is lower than that of the inner portion (i.e., the center portion). This makes it possible to suppress the reaction between the gas containing a halogen element (e.g., chlorine), which is easy to react with the oxygen, and the oxygen existing in the surface layer.

Thus, according to the embodiments, the corrosion of the surface layer of the support member 3 caused by a corrosive gas that easily reacts with oxygen can be suppressed; as such, the support member 3 can have improved corrosion resistance.

An effective technique for reducing the oxygen content of the surface layer of the support member 3 to be less than the oxygen content of the inner portion is to perform a firing process in a firing container containing carbon.

As shown in Table 1, in the support members 3 according to the embodiments, the oxygen content of the surface layer (i.e., the outer peripheral side and the inner peripheral side) is 7.0 (mass %) or less. This enables further improvement of the corrosion resistance of the support member 3 by further suppressing the corrosion of the surface layer of the support member 3 caused by a corrosive gas that easily reacts with oxygen.

As shown in Table 1, in the support members 3 according to the embodiments, the aluminum content of the surface layer (i.e., the outer peripheral side and the inner peripheral side) is lower than the aluminum content of the inner portion (i.e., the center portion). This can restrain a gas containing a halogen element (e.g., chlorine), which is easy to react with aluminum, from reacting with aluminum existing on the surface layer.

Thus, according to the embodiments, the corrosion of the surface layer of the support member 3 caused by a corrosive gas that easily reacts with aluminum can be suppressed; as such, the support member 3 can have improved corrosion resistance.

Note that an effective technique for reducing the aluminum content of the surface layer of the support member 3 to be less than the aluminum content of the inner portion of the support member 3 is to use alumina and yttria as the sintering aid.

Embodiments according to the present invention were described above. However, the present invention is not limited to the embodiments described above, and various modifications can be made without departing from the essential spirit of the present invention.

Additional effects and other aspects can be easily derived by a person skilled in the art. Thus, a wide variety of aspects of the present invention are not limited to the specific details and representative embodiments represented and described above. Accordingly, various changes are possible without departing from the spirit or scope of the general inventive concepts defined by the appended claims and their equivalents.

### REFERENCE SIGNS

1 Optical glass production apparatus

2 High temperature furnace

3 Support member (Example of member for optical glass production apparatus)

4 First member

4a Insertion portion

5 Second member

6 Cover member

7 Raw material supplier

10 Optical glass

11 Glass rod

41 Body portion

42 Enlarged-diameter portion

42a Contact portion

51 Body portion

52 Cavity portion

53 Opening portion

54 Locking portion

55 Slit

143 Stepped portion

144 Support portion

145, 146 External thread portion

153 Stepped portion

155 Internal thread portion

156 Support portion

164 Protruding portion

165 Internal thread portion

1. A member for optical glass production apparatus that is exposed to a gas containing a halogen element in a high temperature environment, the member comprising:
a first member directly or indirectly supporting an optical glass; and
a second member supporting the first member.

2. The member for optical glass production apparatus according to claim 1, wherein
the first member is supported by the second member and is swingable with respect to the second member.

3. The member for optical glass production apparatus according to claim 1, wherein
the second member comprises a cavity portion and an opening portion, the cavity portion being formed inside the second member, and the opening portion penetrating between the cavity portion and a bottom surface and having an inner diameter smaller than an inner diameter of the cavity portion,
the first member comprises an enlarged-diameter portion having an outer diameter that is smaller than the inner diameter of the cavity portion and greater than the inner diameter of the opening portion, and
the enlarged-diameter portion is locked by a locking portion adjacent to an upper end of the opening portion.

4. The member for optical glass production apparatus according to claim 3, wherein a contact portion that is on the enlarged-diameter portion and comes into contact with the locking portion has a tapered shape or a spherical shape.

5. The member for optical glass production apparatus according to claim 3, wherein the locking portion has a tapered shape or a spherical shape.

6. The member for optical glass production apparatus according to claim 3, wherein
the second member comprises a slit on a side surface, the slit connecting the cavity portion and the opening portion while allowing the insertion of the enlarged-diameter portion.

7. The member for optical glass production apparatus according to claim 1, further comprising:
a cover member covering a connecting portion connecting the first member and the second member.

8. The member for optical glass production apparatus according to claim 7, wherein at least one of the first member or the second member comprises a support portion supporting the cover member.

9. The member for optical glass production apparatus according to claim 8, wherein the second member comprises the support portion.

10. The member for optical glass production apparatus according to claim 7, wherein the second member and the cover member comprises a labyrinth structure on opposing surfaces of the second member and the cover member, the opposing surfaces facing each other.

11. The member for optical glass production apparatus according to claim 7, wherein the first member is threadably coupled to the second member.

12. The member for optical glass production apparatus according to claim 7, wherein
the cover member is threadably coupled to the first member.

13. The member for optical glass production apparatus according to claim 7, wherein
the cover member comprises a dense ceramic containing silicon nitride as a main constituent.

14. The member for optical glass production apparatus according to claim 13, wherein
a porosity of a surface layer of the cover member is smaller than a porosity of an inner portion of the cover member.

15. The member for optical glass production apparatus according to claim 1, wherein
the first member comprises a dense ceramic containing silicon nitride as a main constituent.

16. The member for optical glass production apparatus according to claim 15, wherein
a porosity of a surface layer of the first member is smaller than a porosity of an inner portion of the first member.

17. The member for optical glass production apparatus according to claim 15, wherein
the second member comprises a dense ceramic containing silicon nitride as a main constituent.

18. The member for optical glass production apparatus according to claim 17, wherein
a porosity of a surface layer of the second member is smaller than a porosity of an inner portion of the second member.
